(19) United States
(12) Patent Application Publication
(10) Pub. No.: US 2009/0013485 A1
(43) Pub. Date: Jan. 15, 2009

(54) Back Refresher

(76) Inventor: Robert S. Justofin, West Hazleton, PA (US)

Correspondence Address: NW-IP-LAW, 6039 E. Grant RD., Tucson, AZ, 85712, US

(21) Appl. No.: 11/776,366

(22) Filed: Jul. 11, 2007

(51) Int. Cl. A47K 7/04; B25G 1/04

(52) U.S. Cl. 15/143.1; 15/104.001

(57) ABSTRACT

The present invention features a back cleaner comprising a pad having a cleanser attachment side and a handle attachment side and an elongated handle attached to the pad on the handle attachment side via a joint. In some embodiments, the cleanser attachment side of the pad is bulged outward. The joint holding together the elongated handle and the pad together may be locked, or freely moving. In some embodiments, the elongated handle is collapsible.

### FIELD OF THE INVENTION

The present invention is directed to a compact back cleaning device.

### BACKGROUND OF THE INVENTION

For travelers, there are not too many options with respect to cleaning body odor and sweats on the back.

Therefore, there is a need for a device that can provide a way for a traveler to clean himself or herself.

### SUMMARY OF THE INVENTION

The present invention features a back cleaner (i.e., a back refresher) comprising a pad having a cleanser attachment side and a handle attachment side and an elongated handle attached to the pad on the handle attachment side via a joint. In some embodiments, the cleanser attachment side of the pad is bulged outward. The joint holding the elongated handle and the pad together may be locked, or freely moving. In some embodiments, the elongated handle is collapsible.

For use, a person would simply unfold the elongated handle and then place a cleanser onto the pad. The user would then grab the handle, lift his shirt, and begin cleansing his sweaty, oily back. It could also be used to cleanse a person's arms or underarms. The back cleaner would offer travelers, golfers and other sport players a convenient way to refresh themselves between flights, appointments, games, etc. This back cleaner offers a person a quick way to remove sweat, oil, etc., from the back when a shower is not available. It could be simply collapsed for ease in storing and transporting while traveling. The back cleaner may be produced in a variety of colors.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE DRAWINGS

FIG. 1 shows a perspective view of the back cleaner 10.

FIG. 2 shows a front view of a back cleaner 10 and a cleanser 42 to be attached to the cleanser side of the pad 20 via an attachment means, e.g. a Velcro.

FIGS. 3, 4 and 5 show various moveable joints.

FIGS. 6 and 7 show various collapsible elongated handle.

### DESCRIPTION OF PREFERRED EMBODIMENTS

The following is a listing of numbers corresponding to particular elements referred to herein:

10 Back cleaner. Preferably the back cleaner 10 is lightweight, e.g., less than 3 pounds.

20 Pad. The pad 20 may have a dimension of about 2 inches by about 4 inches.

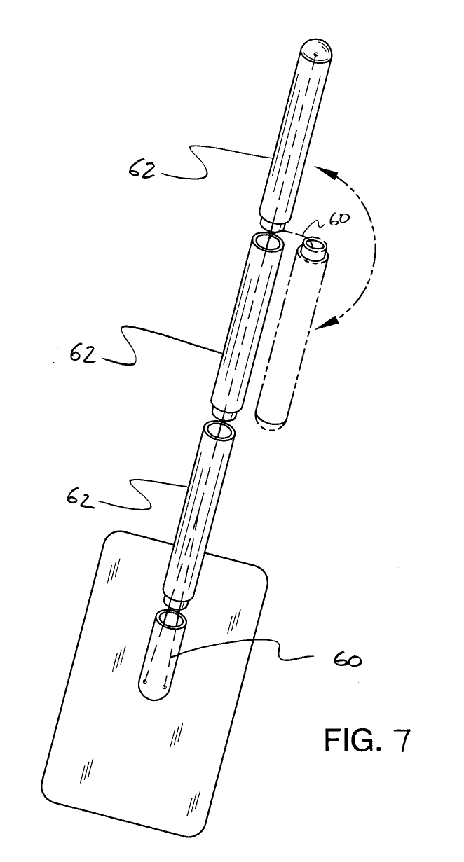

30 Elongated handle. The elongated handle 30 may be about 1 foot when completely elongated, and may be about 6 inches or less when it is collapsed down (see, e.g., FIGS. 6 and 7).

32 Joint that joins the elongated handle and the pad together.

40 Cleanser side of the pad.

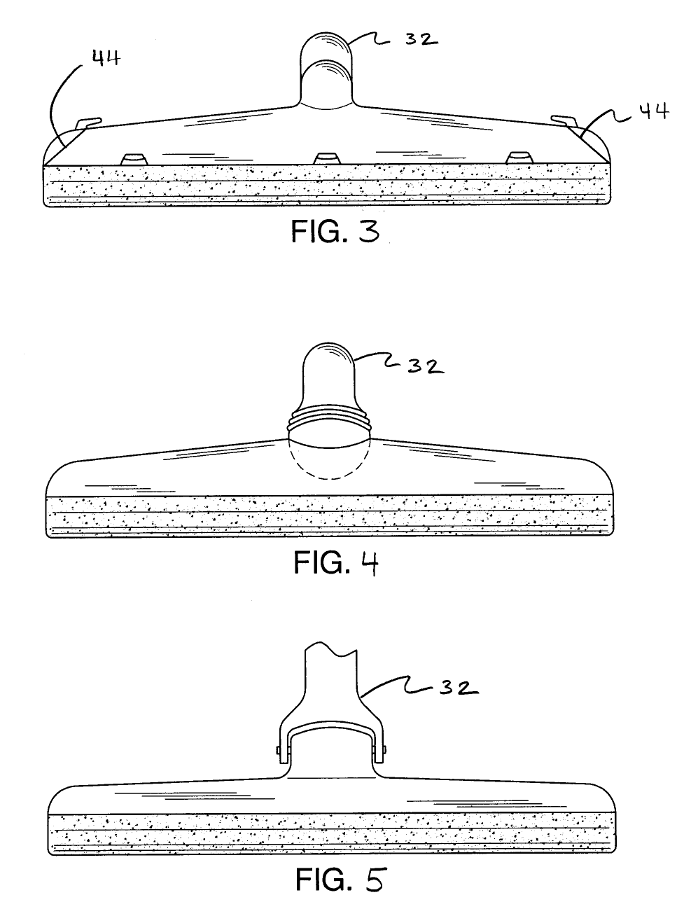

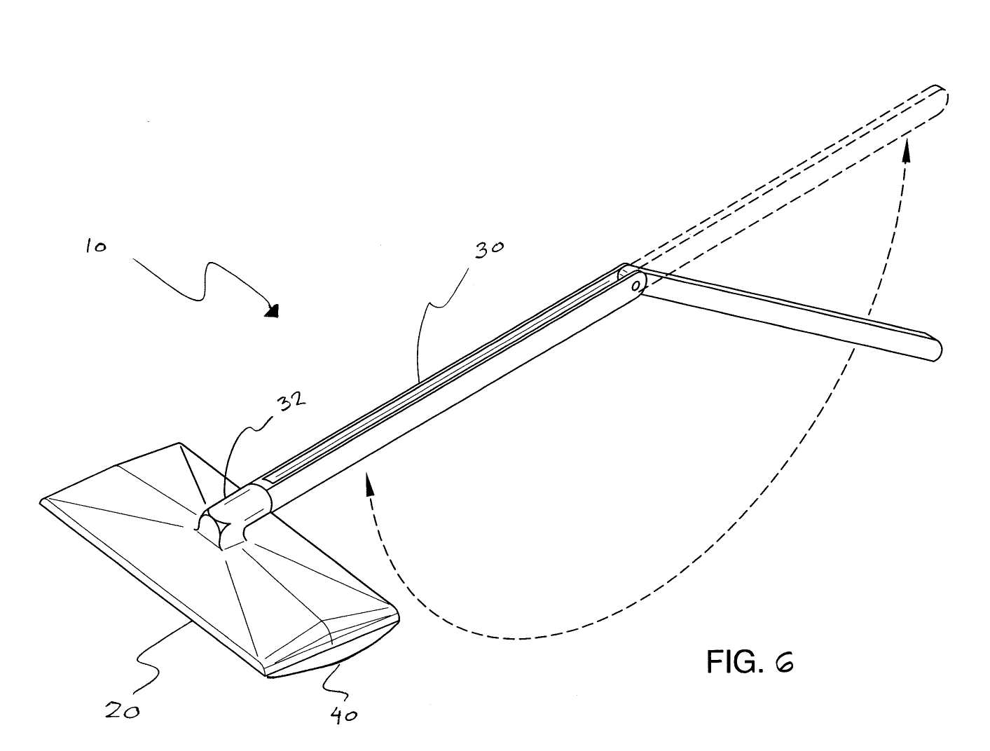

42 Cleanser. The cleanser may be any a wet cloth or paper that can be attached to the cleanser side of the pad via an attachment means, e.g., Velcro, rubber bands and/or claws (see FIGS. 2 and 3).

44 Cleanser attachment means, e.g., Velcro, rubber bands and/or claws. VELCRO® is a brand name of fabric hook-and-loop fasteners used for connecting objects. Hook-and-loop fasteners consist of two layers: a “hook” side, which is a piece of fabric covered with tiny plastic hooks, and a “loop” side, which is covered with even smaller and “hairier” plastic loops. There are many variations to this which include hooks on both sides, for example. When the two sides are pressed together, the hooks catch in the loops and hold the pieces together. When the layers are separated, the strips make a characteristic ripping sound. VELCRO® is patented in U.S. Pat. No. 2,717,437, the disclosure of which is incorporated in its entirety herein by reference.

The present invention features a back cleaner 10 comprising a pad 20 having a cleanser attachment side 40 and a handle attachment side and an elongated handle 30 attached to the pad on the handle attachment side via a joint 32. In some embodiments, the cleanser attachment side 40 of the pad is bulged outward 40. The joint 32 holding together the elongated handle 30 and the pad 20 together may be locked, or freely moving. In some embodiments, the elongated handle 30 is collapsible.

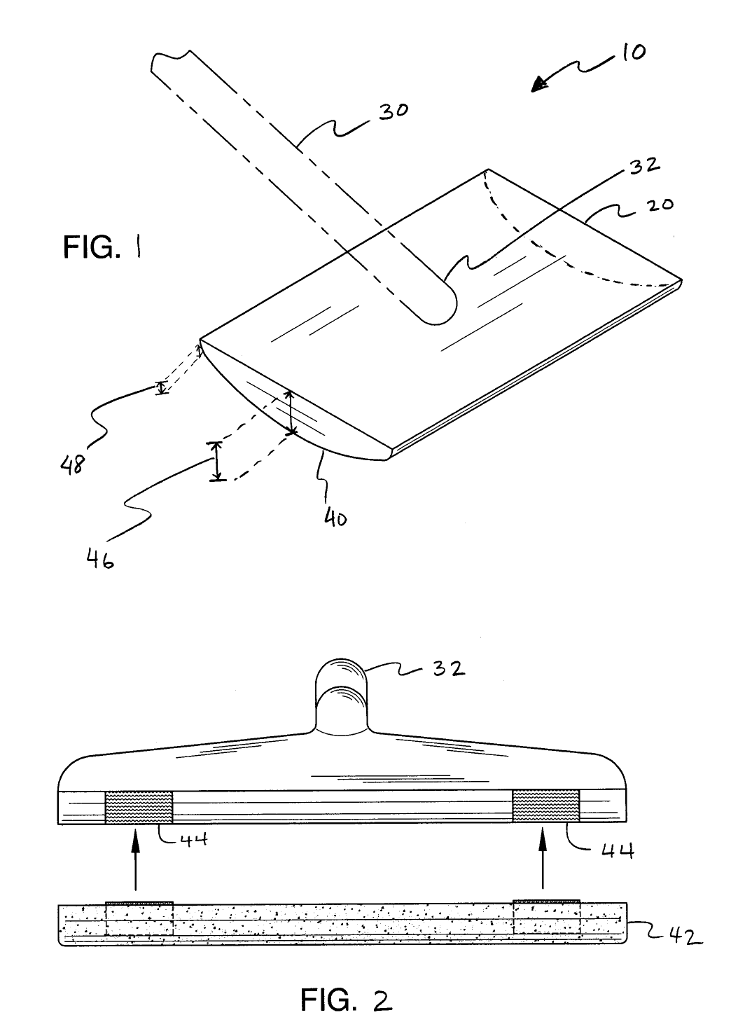

In some embodiments, the back cleaner may be constructed out of plastic and/or metal (e.g. copper). In some embodiments, the outward bulge 40 of the pad 20 may have the following dimensions: the center of the bulge 46 is about 0.50 to about 0.75 inch thick, and the edge of the bulge 48 is less than 0.50 inch thick, e.g. about 0 to about 0.10 inch. In some embodiments, a cross section of the outward bulge 40 has a shape of an arch. See FIG. 1.

The cleanser 42 may be attached to the cleaner side of the pad 40 by any means, e.g., Velcro (FIG. 2) or rubber bands (FIG. 3).

The joint 32 joining the pad 20 to the elongated handle 30 may be locked (FIG. 6) or freely moving, e.g., FIGS. 3 and 4 show a ball and socket joint and FIG. 5 shows a swivel joint.

The elongated handle 30 may be collapsed via various ways. For example, FIG. 3 shows that the elongated handle 30 may be collapsed by bending the elbow joint. FIG. 7 shows that the elongated handle 30 may be collapsed by dismembering the separate tubes 62 that are joined together by an internal elastic (e.g., rubber band) 60 to form the elongated handle 30.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

What is claimed is:

1. A back cleaner comprising:
(a) a pad having a cleanser attachment side and a handle attachment side;
(b) an elongated handle attached to the pad on the handle attachment side via a locked joint;
the cleanser attachment side of the pad is bulged outward, a center of the bulge is about 0.50 to about 0.75 inch thick, and an edge of the bulge is less than 0.50 inch thick.

2. A back cleaner comprising:
(c) a pad having a cleanser attachment side and a handle attachment side;
(d) an elongated handle attached to the pad on the handle attachment side via a locked joint;
the cleanser attachment side of the pad is bulged outward.

3. A back cleaner comprising:
(a) a pad having a cleanser attachment side and a handle attachment side;
(b) an elongated handle attached to the pad on the handle attachment side via a joint;
the cleanser attachment side of the pad is bulged outward.

4. The back cleaner of claim 3, wherein the elongated handle is collapsible.
